(19) United States
(12) Patent Application Publication
(10) Pub. No.: US 2016/0057238 A1
(43) Pub. Date: Feb. 25, 2016

(54) GENERATING A PROXIMITY SOCIAL NETWORK

(71) Applicant: Richard T. Oldacre, Royal Palm Beach, FL (US)

(72) Inventor: Richard T. Oldacre, Royal Palm Beach, FL (US)

(21) Appl. No.: 14/465,363

(22) Filed: Aug. 21, 2014

(51) Int. Cl. H04L 29/08; G06Q 30/02; G06Q 50/00; H04L 29/06; H04W 4/02

(52) U.S. Cl. CPC H04L 67/18; H04L 65/403; H04W 4/025; G06Q 50/01; G06Q 30/0269

(57) ABSTRACT

The present application relates to a system for proximity-based social networking, wherein the system comprises: two or more computing devices, wherein each of the two or more computing devices comprises a storage device storing a social networking application and a user profile; a connectivity device that connects to each of the two or more computing devices, at the same time, when each of the two or more computing devices are within a defined proximity of the connectivity device, wherein via the connectivity device a social networking session is established between the two or more computing devices using the social networking application that is stored on the storage device of each of the two or more computing devices.

### CLAIM FOR PRIORITY AND INCORPORATION BY REFERENCE

This application claims the benefit of U.S. Provisional Patent Application No. 61/869,280 named “Generating A Proximity Social Network,” which was filed on Aug. 23, 2013, the disclosure of which is incorporated herein by reference in its entirety.

### BACKGROUND

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Qwintro, LLC, 2013. All Rights Reserved.

A social networking service is an online service, platform or site that allows members to build or reflect social networks or social relations among members. Typically, members construct profiles, which may include personal information such as name, contact information, employment information, photographs, music, computer files, personal messages, status information, and links to web related content, blogs, and so on. Typically, only a portion of a member's profile may be viewed by the general public and/or other members.

The traditional social networking site allows members to identify and establish links or connections with other members in order to build or reflect social networks or social relations among members. For instance, in the context of a business networking service, a person may establish a link or connection with his or her business contacts, including work colleagues, clients, customers, and so on. With a social networking service, a person may establish links or connections with his or her friends and family. A connection is generally formed using an invitation process in which one member “invites” a second member to form a link. The second member then has the option of accepting or declining the invitation. If the second member accepts the invitation, the first and second members are connected.

In general, a connection or link may represent or may be otherwise associated with an information access privilege, such that a first person who has established a connection with a second person is, via the establishment of that connection, authorizing the second person to view or access non-publicly available portions of their profiles. Of course, depending on the particular implementation of the business/social networking service, the nature and type of the information that may be shared as well as the granularity with which the access privileges may be defined to protect certain types of data may vary greatly.

A variety of different social networking services have gained popularity, including FACEBOOK® of Palo Alto, Calif., MYSPACE® of Beverly Hills, Calif. and run by News Corp., LINKEDIN® of Mountain View, Calif., TWITTER® of San Francisco, Calif., and the like. These sites often allow for third party applications to utilize certain functionality provided by the host social networking service. In some examples, these third party applications may utilize certain user interface (UI) elements of the social networking service, access personal information about a user (including profile information), and send and receive social interactions, such as messages, to the user of the third party application or to their connections. FACEBOOK®, for example, allows developers to create applications which are integrated into the FACEBOOK® user interface and with the FACEBOOK® social networking system. In some examples, these applications may include games such as CITYVILLE®, FARMVILLE®, and MAFIA WARS®, all developed by ZYNGA®, Inc. of San Francisco, Calif. These applications appear in a FACEBOOK® page, and make use of various features of FACEBOOK®, such as contacting friends to encourage them to join the game and play with the user and the like.

The social networking services integrate with these applications by providing to these applications an Application Programming Interface or “API.” In general, an API is a particular set of rules and specifications that a software program may follow to access and make use of the services and resources provided by another particular software program that implements that API. The API serves as an interface between different software programs and facilitates their interaction.

### BRIEF SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention relate to systems and methods for generating a proximity-based social network for a plurality of users based either on a location of the plurality of users or based on an event associated with each of the plurality of users. According to some embodiments of the invention, an application is downloaded or installed onto each of a plurality of mobile devices, computers, electronic devices, or memory associated with each of a plurality of mobile devices. When it is determined that, at least, two or more of the plurality of mobile devices having the application are in sufficient relative geographic proximity to each other or a local area network, a system automatically and dynamically generates a social network between, at least, the two or more of the plurality of mobile devices. The mobile devices are then linked via a common network or server, such that information associated with the users of the, at least, two or more of the plurality of mobile devices is automatically shared to those devices. In many instances, no prior link between the plurality of mobile devices is required for linking each of the mobile devices into a newly generated instant social network.

In an exemplary embodiment of the present invention, a host manages a server or other computing device configured for engaging a social networking service and provides wireless connectivity (e.g., using a wireless router) for generating a social networking session for the social networking service. The host may be any kind of entity including, in some embodiments, a business merchant, a user (i.e., individual), any type of entity or organization including the entity providing the social networking application describe herein. Some time prior to or contemporaneously with a social networking session, the host generates or creates a host page/s. A host page may include information about the host, promotions, offers, request for information, client information, and/or the like. The server may be used to collect data from users participating in the social networking session, as well as for interacting with said users. When a user having a mobile device with a social network application associated with the social networking information downloaded or installed thereon enters a social networking zone created by the host, the social networking application on the user's mobile device uploads to the host server a user profile. Similarly, upon entering the social networking zone, the host page (or host profile) is automatically downloaded to the mobile device of the user. The download includes profile and requisite information regarding all users currently connected to the host. The user via the mobile device can communicate and share information/data with the host and/or with any other user who is participating in the social networking session within the social networking zone created by the host. During the social networking session, the host may engage users participating in the social networking session in a real-time or substantially real-time impromptu forum. In this way, the host can communicate with users and receive insights and feedback.

Unlike traditional social networking sites and/or services, the present invention does not necessarily require users of the service to have some prior connection or even that a user invites another user to establish a connection over the social networking service. It is not required for the user prior knowledge or information regarding other connected users or their device such as name, phone number, or other identifying characteristics. Instead, using the present invention, a social networking community or group is created when users having mobile devices enter a social networking zone. Any user within the zone can communicate with one another and share information without having to establish a connection via an invitation to connect. A user may join the social networking community by merely entering the social networking zone. And similarly, exit the social networking community by moving outside of the social networking zone. Of course, the mobile device of the user must have a specific social networking application that allows for the instant and/or spontaneous social networking.

Further, in contrast to traditional social networking sites, and in some embodiments of the present invention, a user's social networking information, such as the user's profile and associated information is stored in a memory of the user's mobile device. In this way, one or more users can engage in a social networking session wherever the one or more users travel with their respective mobile devices. Because, in many embodiments, the instant social network created by the present invention is not hosted on a traditional social networking server, but instead, the instant social network is created by a local connectivity router and/or a local host server and one or more devices that are located in close geographic proximity to the connectivity router. As an example, a wireless router operatively connected to a random host server may have a radius of connectivity of approximately 30 feet. In such an example, the 30 feet radius of the router creates a social networking zone in which one or more users can engage in a social networking session. Within the 30 feet radius, four user's having mobile devices which have a proximity-based social networking application may instantly engage in a social networking session that includes only the four user's and potentially the random host server that is in communication with the wireless router. Further, in such an example, each graphical user interface of each of the user's mobile devices will populate with user profile information of the other three users within the social networking zone (30 ft. radius) and potentially a profile associated with the host server. As demonstrated by the example, the user's do not have to be in communication or otherwise connected to a social networking server for creating a social network, as their user profile information is stored on each user's respective mobile device and connectivity between the users is provided by the local wireless router. And so, in many embodiments, the Internet is not required for creating the social network between users, but only a connectivity device. Thus, creating an instant proximity-based local social network that involves only the users and potentially a local host server who are geographically proximate to each other and are connected by a common local connectivity device that is also in geographic proximity to each of the users and the host server. However, it should be noted that, in some embodiments, user profile information may be stored in a traditional social networking server and/or stored on the user's mobile device. Thus, upon entering the social networking zone the user profile information stored on the networking server may be shared with each user within the social networking zone.

Thus, according to embodiments of the present application, a system for proximity-based social networking is provided, wherein the system comprises: two or more computing devices, wherein each of the two or more computing devices comprises a storage device storing a social networking application and a user profile; a connectivity device that connects to each of the two or more computing devices, at the same time, when each of the two or more computing devices are within a defined proximity of the connectivity device, wherein via the connectivity device a social networking session is established between the two or more computing devices using the social networking application that is stored on the storage device of each of the two or more computing devices.

In some embodiments, the system further comprises a host server that is in operative communication with the connectivity device, wherein the host server manages the connectivity device.

In some embodiments, the connectivity device comprises a wireless router having a defined radius of connectivity.

In some embodiments, the social networking session is established within the defined radius of connectivity of the wireless router.

In some embodiments, the connectivity device comprises a mobile computing device of user that which comprises wireless routing capabilities.

In some embodiments, the connectivity device establishes a social networking zone, wherein the social networking zone is a geographical area defined by a connectivity range of the connectivity device, wherein only the computing devices within the social networking zone can engage in the social networking session.

In some embodiments, the social networking session is established without a use of Internet.

According to other embodiments of the present application, a system for providing a proximity-based social networking session is provided, wherein the system comprises: a connectivity device generating a wireless local area network; and a first mobile computing device of a first user; a second mobile computing device of a second user, wherein the first and the second mobile computing devices each comprise a storage device, wherein the storage device for each of the first and second mobile computing devices comprises a user profile for a social networking service and social networking information, and wherein a social networking session between the first mobile computing device and the second mobile computing device only when the first and the second mobile computing devices are geographical positioned within a defined range of the wireless local area network generated by the connectivity device.

In some embodiments, the system further comprises a host server that is in operative communication with the connectivity device, wherein the host server manages the connectivity device.

In some embodiments, the system further comprises a social networking service provider that is in operative communication with the connectivity device, wherein the social network service provider comprises a server or a computer that manages the connectivity device.

In some embodiments, the connectivity device is a wireless router having a defined radius of connectivity.

In some embodiments, the social networking session is established within the defined radius of connectivity of the wireless router.

In some embodiments, the social networking session is established without a use of Internet.

According to some embodiments, m method for establishing a proximity-based social networking session is provided, wherein the method comprises: establishing, by a connectivity device, a social networking zone, wherein the social networking zone is geographically defined by a connectivity range of the connectivity device; connecting, via the connectivity device, a plurality of computing devices that are within the social networking zone established by the connectivity device; and maintaining, via the connectivity device, a social networking session between at least two of the plurality of computing devices that are within the social networking zone, wherein the social networking sessions comprises sharing user information between at least two or more of the plurality of computing devices within the social networking zone.

In some embodiments, the plurality of computing devices is mobile devices, wherein each of the mobiles devices is associated with at least one user.

In some embodiments, maintaining, via the connectivity device, the social networking session is performed by a host, wherein the host is a business merchant that is different from a social network service provider.

In some embodiments, the host collects information from and shares information or offers with one or more of the plurality of computing devices within the social networking zone and that are engaged in the social networking session.

In some embodiments, the plurality of computing devices comprises mobile computing devices.

In some embodiments, the social networking session is established without a use of Internet.

It will be understood that the embodiments described above and herein may be combined with any other feature disclosed within the present application for implementing any method or process disclosed herein or otherwise could be conceived based on the present disclosure. Similarly, the features of the embodiments of the present application may be combined in any manner to provide a system, apparatus/device, and/or a computer program product for implementing the overall concept and variations thereof.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a system environment 100 for generating a proximity social network based at least partially on an event and/or a location, in accordance with one embodiment of the present invention.

FIG. 1A is a block diagram that illustrates a user mobile device (hereinafter the “mobile device”) of FIG. 1 in more detail, in accordance with an embodiment of the present invention.

FIG. 1B is a block diagram illustrating architecture of a social network service server of FIG. 1 in more detail, in accordance with some embodiments of the present invention.

FIG. 2 illustrates a general process flow 200 for dynamically generating a social network among a plurality of mobile devices based at least partially on an event or one or more locations associated with each of the mobile devices, in accordance with one embodiment of the present invention.

FIG. 3 illustrates a general process flow 300 for providing a web-based proximity social network service, in accordance with an embodiment of the present invention.

FIG. 4 illustrates a general process flow 400 for engaging a proximity social network by a host, in accordance with one embodiment of the present invention.

FIG. 5 illustrates a system environment 500 for generating an instant social network session between at least two proximity-based social networking sessions, in accordance with one embodiment of the present invention.

### DETAILED DESCRIPTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, and/or operational aspects of any of the embodiments described and/or contemplated herein may be included in any other embodiment of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

Generally, the phrase “social networking information,” as used herein refers to information or data associated with at least one social network service and/or one or more users of the social network service. In some embodiments, the social network information is content data associated with the social network service. The content data may include, but is not limited to, image data, textual data, video data, sound data, blog data, podcast data, form data, interest data, interest group data, user-generated content, social network service-generated content, and/or the like. In some embodiments, the social network information is associated with one or more users associated with a social network service. In some embodiments, the social network information is non-content data associated with the social network service. The non-content data may include, but is not limited to, user activity data, social network service usage data, information about content data including metadata about content data objects, information about the social network service, information about the users of the social network service (e.g., user profiles), and/or the like.

Generally, the phrase “social networking zone,” as used herein generally refers to a defined geographic area wherein within the defined geographic area one or more social network services may allow users to engage in one or more social networking sessions. In some embodiments, the social networking zone is defined by the range of a single wireless or multiple wireless connectivity devices, such as a wireless router. In such an embodiment, any computing devices and/or mobile devices that are within the range of the wireless router may engage in a unique social networking session with any other computing device and/or mobile device that are also within the range of the wireless connectivity device. As such, a social networking session is defined by the one or more mobile devices and/or computing devices within the social networking zone and, in some embodiments, further temporally defined by a specific period of time. Some social networking sessions only last for a specific period of time and/or for, as long as, the wireless connectivity device is used for generating the social networking zone.

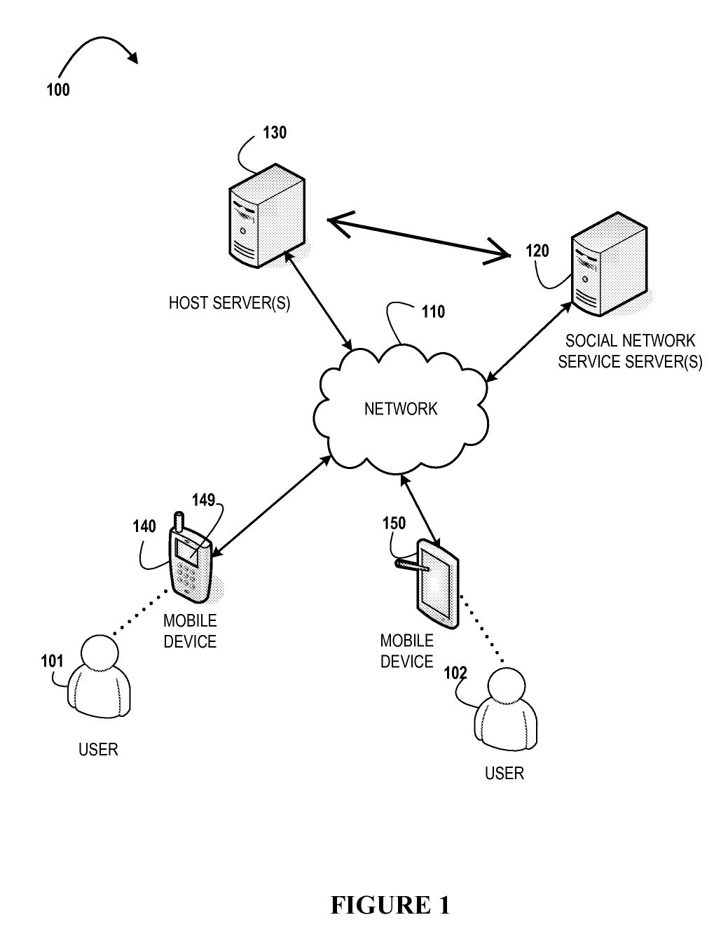

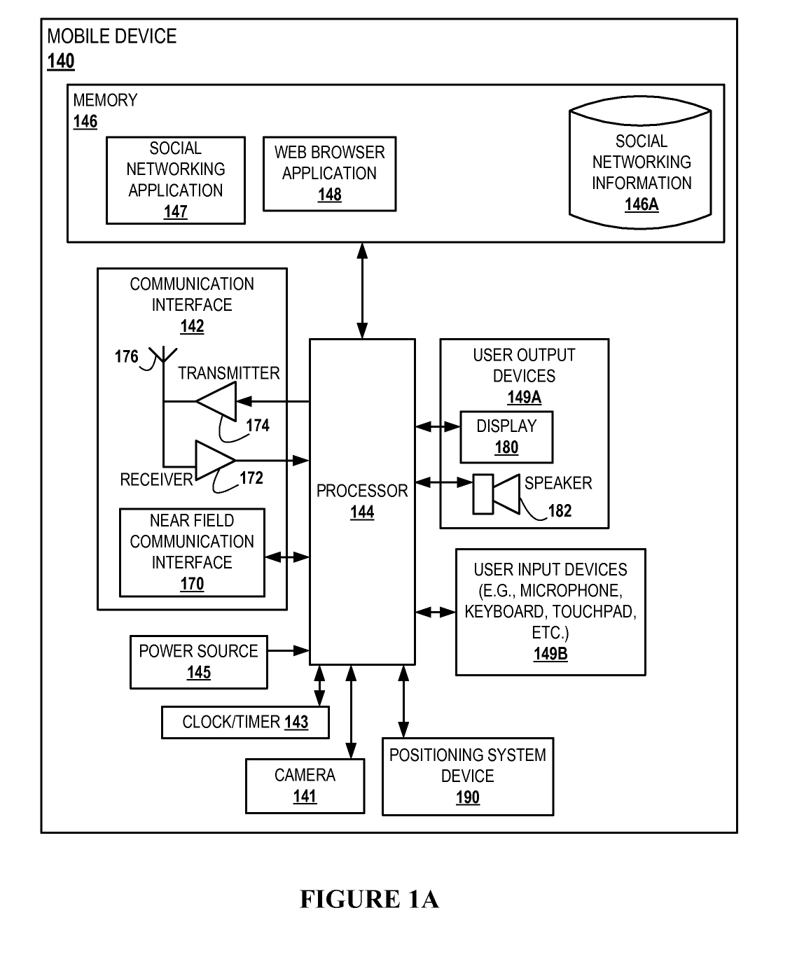

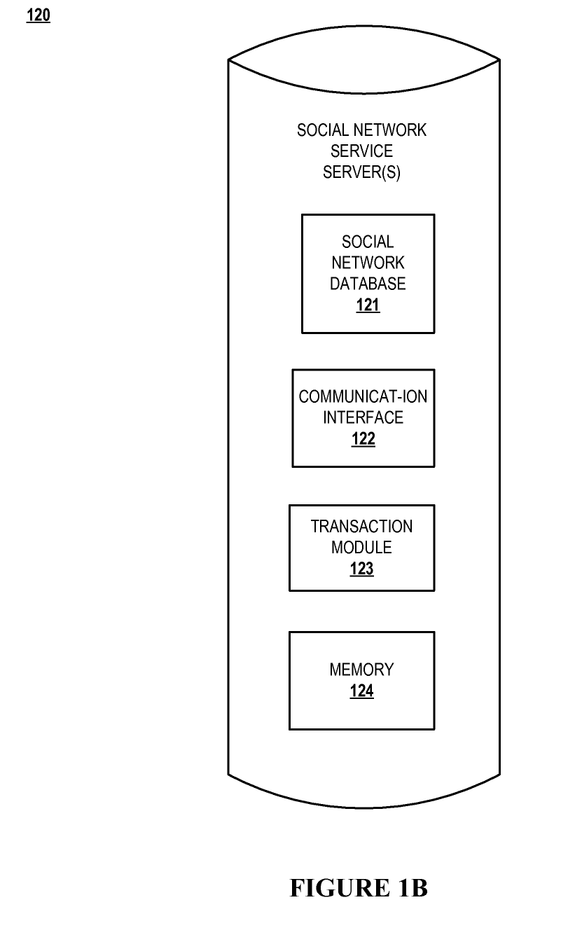

Referring now to FIG. 1, a system environment 100 is provided for generating a proximity social network based at least partially on an event and/or a location, in accordance with one embodiment of the present invention. As illustrated the system environment includes a network 110, a social network service server 120, a host server 130, a first user mobile device 140, and a second user mobile device 150. A first user 101 and a second user 102, in some embodiments, are associated with the first user device 140 and the second user device 150, respectively, and/or is carried, operated, controlled, possessed, and/or owned by first user 101 and/or second user 102, respectively.

As shown in FIG. 1, the social network service server 120, the host server 130, mobile device 140, and mobile device 150 are each operatively and selectively connected to the network 110, which may include one or more separate networks. The network 110 may include one or more telephone networks, telecommunication networks, cellular networks, NFC networks, local area networks (LANs), wide area networks (WANs), and/or global area networks (GANs) (e.g., the Internet, etc.). It will also be understood that the network 110 may be secure and/or unsecure and may also include wireless and/or wireline technology. Also, as shown in FIG. 1, mobile device 140 and mobile device 150 are directly, selectively, and/or operatively connected to the server 120 via one or more wireline and/or wireless connections. As an example, network 110 may be formed by a social network service wireless router or other network connectivity device, such that mobile device 140 and mobile 150 may communicated social network information with each other, as well as with each of a host server 130 and a social network service server 120.

Referring now to FIG. 1A, a block diagram is provided that illustrates the first user mobile device 140 or the second user mobile device 150 (hereinafter the “mobile device”) of FIG. 1 in more detail, in accordance with an embodiment of the present invention. In some embodiments, the mobile device is a mobile phone, but in other embodiments, the mobile device can include and/or be embodied as any other mobile device described and/or contemplated herein. The mobile device can be configured to initiate, perform, transmit, complete, and/or facilitate any portion of any embodiment described and/or contemplated herein as being initiated, performed, completed, and/or facilitated by a mobile device. As shown in FIG. 1A, the mobile device includes a processor 144 operatively connected to memory 146, user output devices 149A, user input devices 149B, a communication interface 142, a power source 145, a clock or other timer 143, a camera 141, and a positioning system device 190.

The processor 144 may include the functionality to encode and interleave messages and data prior to modulation and transmission. The processor 144 can additionally include an internal data modem. Further, the processor 144 may include functionality to operate one or more software programs, which may be stored in the memory 146. For example, the processor 144 may be capable of operating a connectivity program, such as a web browser application 148. The web browser application 148 may then allow the mobile device to transmit and receive web content, such as, for example, location-based content and/or other web page content, according to a Wireless Application Protocol (WAP), Hypertext Transfer Protocol (HTTP), and/or the like.

The processor 144 is configured to use the communication interface 142 to communicate with one or more other devices on the network 110. In this regard, the communication interface 142 includes an antenna 176 operatively coupled to a transmitter 174 and a receiver 172 (together a “transceiver”). The processor 144 is configured to provide signals to and receive signals from the transmitter 174 and receiver 172, respectively. The signals may include signaling information in accordance with the air interface standard of the applicable cellular system of the wireless telephone network 110. In this regard, the mobile device may be configured to operate with one or more air interface standards, communication protocols, modulation types, and access types. By way of illustration, the mobile device may be configured to operate in accordance with any of a number of first, second, third, and/or fourth-generation communication protocols and/or the like. For example, the mobile device may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device may also be configured to operate in accordance with non-cellular communication mechanisms, such as via a wireless local area network (WLAN) or other communication/data networks.

The communication interface 142 of the mobile device may also include an NFC interface 170. The NFC interface 170 is configured to contactlessly and/or wirelessly send and/or receive information over relatively short ranges (e.g., within four inches, within three feet, etc.). The NFC interface 170 may include a transmitter, receiver, smart card, key card, proximity card, radio frequency identification (RFID) tag and/or reader, and/or the like. In some embodiments, the NFC interface 170 communicates information via radio, IR, and/or optical transmissions. In some embodiments, the NFC interface 170 is configured to operate as an NFC transmitter and/or as an NFC receiver (e.g., an NFC reader, etc.). In some embodiments, the NFC interface 170 enables the mobile device to operate as a mobile wallet. Also, it will be understood that the NFC interface 170 may be embedded, built, carried, and/or otherwise supported in and/or on the mobile device. In some embodiments, the NFC interface 170 is not supported in and/or on the mobile device, but the NFC interface 170 is otherwise operatively connected to the mobile device (e.g., where the NFC interface 170 is a peripheral device plugged into the mobile device, etc.). Other apparatuses having NFC interfaces mentioned herein may be configured similarly.

In some embodiments, the NFC interface 170 of the mobile device is configured to contactlessly and/or wirelessly communicate information to and/or from a corresponding NFC interface of another apparatus. For example, in some embodiments, the mobile device is a mobile phone; the NFC interface 170 is a smart card having social networking information associated with a social networking service stored therein. In such embodiments, when the mobile phone and/or smart card is brought within a relatively short range of the NFC reader, the smart card is configured to wirelessly and/or contactlessly send the social networking information to the NFC reader in order to share or communicate social networking information with one or more other devices.

In addition to the NFC interface 170, the mobile device can have a user interface 149 that is, like other user interfaces described herein, made up of one or more user output devices 149A and/or user input devices 149B. The user output devices 149A include a display 180 (e.g., a liquid crystal display, a touchscreen display, and/or the like) and a speaker 182 and/or other audio device, which are operatively coupled to the processor 144. The user input devices 149B, which allow the mobile device to receive data from a user such as the holder 102, may include any of a number of devices allowing the mobile device to receive data from a user, such as a keypad, keyboard, touch-screen, touchpad, microphone, mouse, joystick, other pointer device, button, soft key, and/or other input device(s). The user interface 149 may also include a camera 141, such as a digital camera.

In some embodiments, the communication interface 142 is configured with similar or additional short-distance or short-range communication technologies, such as Bluetooth. In such an embodiment, using Bluetooth capabilities, computing devices within a social networking zone may exchange data and information. It will be understood that any form of wireless and wireline technologies may be used to allow users, hosts, connectivity devices to communicate with each other and/or otherwise implement the inventions described herein or any of the process flows disclosed herein.

In some embodiments, the mobile device also includes a positioning system device 190 that can be used to determine the location of the mobile device. For example, the positioning system device 190 may include a GPS transceiver. In some embodiments, the positioning system device 190 is at least partially made up of the antenna 176, transmitter 174, and receiver 172 described above. For example, in one embodiment, triangulation of cellular signals may be used to identify the approximate location of the mobile device. In other embodiments, the positioning system device 190 includes a proximity sensor and/or transmitter, such as an RFID tag, that can sense or be sensed by devices known to be located proximate a wireless router and/or other locations to determine that the mobile device is located proximate these known devices.

The mobile device further includes a power source 145, such as a battery, for powering various circuits and other devices that are used to operate the mobile device. Embodiments of the mobile device may also include a clock or other timer 143 configured to determine and, in some cases, communicate actual or relative time to the processor 144 or one or more other devices.

The mobile device also includes a memory 146 operatively connected to the processor 144. The memory 146 can store any of a number of applications which may include computer-executable program code executed by the processor 144 to implement the functions of the mobile device described herein. For example, the memory 146 may include such applications as a web browser application 148 and/or a social networking application 147. It will be understood that the web browser application 148 and/or the social networking application 147 can be, individually or collectively, operable to initiate, perform, complete, and/or facilitate one or more portions of any embodiment described and/or contemplated herein, such as, for example, any one or more portions of the process flows 200 and/or any other process flow described herein.

For example, in some embodiments, the social networking application 147 is executable to authenticate the holder 102. As another example, in some embodiments, the social networking application 147 is executable to prompt (e.g., via the user interface 149) the holder 102 to input, into the mobile device, information for initiating one or more social networking sessions. As still another example, in some embodiments, the social networking application 147 is executable to automatically initiate one or more social networking sessions. As another example, in some embodiments, the social networking application 147 is executable to store social networking information associated with one or more social networking sessions, where the social networking information is stored in the social networking information datastore 146A and/or elsewhere in the memory 146. As another example, in some embodiments, the social networking application 147 is executable to store authentication information associated with one or more social networking services. As still another example, in some embodiments, the social networking application 147 is executable to present information associated with one or more social network service to the holder 102 and/or to prompt the holder to select one or more social networking sessions to participate in when one or more social networking sessions are available to the mobile device of the holder 102. As another example, in some embodiments, the social networking application 147 is executable to transmit social networking information associated with the one or more social networking service directly and/or indirectly between the mobile device, the server, and/or another user mobile device.

In some embodiments, the social networking application 147 and/or the web browser application 148 is executable to enable the holder 102 and/or mobile device to communicate with one or more other portions of the system 100, and/or vice versa. In some embodiments, the social networking application 147 and/or the web browser application 148 is additionally or alternatively executable to initiate, perform, complete, and/or otherwise facilitate one or more, social networking transactions, financial and/or non-financial transactions. In some embodiments, the social networking application 147 and/or the web browser application 148 includes one or more computer-executable program code portions for causing and/or instructing the processor 144 to perform one or more of the functions of the social networking application 147, web browser application 148, and/or mobile device described and/or contemplated herein. In some embodiments, the social networking application 147 and/or the web browser application 148 includes and/or uses one or more network and/or system communication protocols.

In some embodiments, the social networking application 147 and/or the web browser application 148 are executable to render and/or otherwise provide a graphical user interface on the display 180 that allows the holder 102 to communicate with the mobile device and/or one or more other portions of the system 100. The memory 146 can also store any type and/or amount information used by the mobile device, and/or used by the applications and/or the devices that make up the mobile device and/or that are in communication with the mobile device, to implement the functions of the mobile device and/or the other systems described and/or contemplated herein. For example, in some embodiments, the memory 146 stores account information (e.g., routing and/or account numbers, account names, etc.), authentication information (e.g., username/passwords, PINs, tokens, biometric information, etc.) for performing a transaction with the mobile device in the memory 146.

FIG. 1 also illustrates social network service server(s) 120 and host server(s) 130, in accordance with some embodiments of the present invention. The social network service server 120 can include any server and/or apparatus described and/or contemplated herein. Additionally or alternatively, the server 130 can be configured to initiate, perform, complete, and/or facilitate any portion of any embodiment described and/or contemplated herein as being initiated, performed, completed, and/or facilitated by a server and/or apparatus. In some embodiments, the server 130 includes one or more servers, engines, mainframes, personal computers, mobile devices, network devices, front end systems, back end systems, and/or the like. It will be understood that the server 130 may include a communication interface, a processor, and a memory, which may include one or more applications and/or datastores.

FIG. 1B a block diagram is provided illustrating example architecture of a social network service server 120 of FIG. 1 in more detail, in accordance with some embodiments of the present invention. Server 120 includes a web-based social network database 121, a communication interface 122, transaction module 123, and memory 124.

The web-based social network database 121 may be used to store social networking information, which may include user social networking profile information, social networking activity information of the social networking service, host server 130 activity information, and/or any other information and data relating to the operation and/or functionality of system 100.

The communication interface 122 may be used to communicate with any device/apparatus within system 100 including mobile device 140, mobile device 150, and host server 130. Any user activity and/or host server activity occurring in the system maybe time-tagged and logged in memory 124. Thus, memory 124 may include a data log of all and any activity occurring within system 100.

In some embodiments, social network service server 120 is configured (and/or an application thereof is executable) to store in social network database 121 one or more profiles for each user having an account with the social network service maintaining server 120. Server 120 may automatically or selectively upload to a user mobile device a user profile, host information, and user profile data based on a location of the mobile device and/or detecting a presence of a host wireless router or server. In some embodiments, server 120 is configured to automatically or selectively upload to a host server a user profile or user profile data based on determining that a user mobile device associated with the user profile is in proximity or within a social networking zone associated with the host server. Also, in some embodiments, the server 120 includes one or more applications, where those one or more applications include one or more computer-executable program code portions for causing and/or instructing the processor of the server 120 to perform one or more of the functions of the server 120 described and/or contemplated herein. In some embodiments, the server 120 includes and/or uses one or more network and/or system communication protocols.

It will be understood that some or all portions of system 100 are combined into a single portion. Specifically, in some embodiments, the social networking service server 120 and host server 130 are within the same server and/or alternatively, are each managed, maintained, and/or controlled by one entity. Likewise, in some embodiments, some or all of the portions of the system 100 are separated into two or more distinct portions. In addition, the various portions of the system 100 may be maintained by the same or separate entities.

It will also be understood that the system 100 and/or one or more portions of the system 100 may include and/or implement any embodiment of the present invention described and/or contemplated herein. For example, in some embodiments, the system 100 (and/or one or more portions of the system 100) is configured to implement any one or more embodiments of the process flows 200, 300, and/or 400 described and/or contemplated herein.

It will also be understood that although the system environment 100 displays mobile devices as the operative element for engaging in a proximity-based social networking session, any computing device may be used in the present invention for engaging in the proximity based social networking session. For example, a wireless wearable computing device, a desktop computer, and/or computing kiosk which may be in communication with a connectivity device via a wireline connection may be equally used for engaging in a social networking session, as described in the present invention.

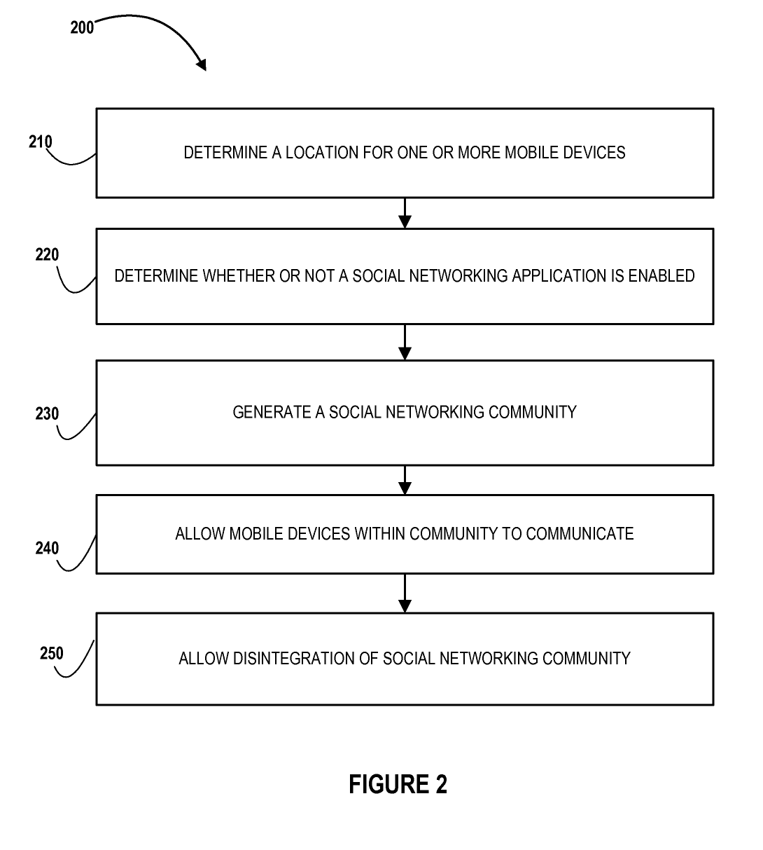

Referring now to FIG. 2, a general process flow 200 is provided for dynamically generating a social network among a plurality of mobile devices based at least partially on an event or one or more locations associated with each of the mobile devices, in accordance with one embodiment of the present invention. As represented by block 210, the system detects one or more of mobile devices having a social networking application within the social network zone. The location of each of the one or more mobile devices may be determined in various ways, including by using a wireless router, check-in functionality, host connection location, a server-determined geographic location, and/or the like. The system determines the location of the one or more mobile devices for determining whether any of the one or more mobile devices is in or proximate to a system-generated social networking zone.

In some embodiments, a wireless router specifically configured for initiating a social networking session detects the presence of one or more mobile devices to thereby initiate a new social networking session. The wireless router may communicate directly with a positioning system or component of each of the one or more mobile devices in order to determine the respective geo-locations of each mobile device. In some embodiments, when the social networking session is designated for a predetermined zone (social networking zone) where multiple zones embody the network and/or predetermined area location (e.g., a particular building location, a room in a building, a predefined two-dimensional geographic area, and the like) where multiple locations embody the network, the wireless router and/or a system associated with the wireless router compares the determined locations of each of the one or more mobile devices to the predetermined zone and/or the predetermined area location that is designated for the social networking session. When the wireless router and/or the system detect a match between a mobile device location and the predetermined zone, the system adds the mobile device associated with the match to the social networking session occurring only within the predetermined zone or location. As an example, an entity may host an event in a particular room of a multi-room hotel. Within the particular room, the host of the event may setup or designate a wireless router or wireless network device for specifically creating or initiating a social network. In such an example, the router may be setup such that the specific dimensions/parameters and/or location of the room are used to limit or define the scope of any social networking session that is initiated and/or generated using the router. Continuing with the example, once at least one user having a mobile device enters the particular room, the router or a system managing the router is set to detect the mobile device, assimilate the device into the network, and provide the user with access to the particular room-specific and/or event-specific social network. Thus, the social networking session is defined by the reasonable parameters/dimensions of the particular room, such that if the user exits the room, the user would no longer have access to the social network session occurring for the predefined area in the multi-room hotel. This aspect of the invention may be significant because, in many embodiments, the social networking session may only be initiated or exists in a predefined location, a predefined area, and requisite host entity. Outside of the predefined location or predefined area, any user/profile information or other users or host/profile information is restricted or otherwise destroyed from the mobile device of the user who is no longer within the predetermined location or predefined area, such that the user cannot access or view the profile information of other users who continue to be located within the predetermined location or predefined area or otherwise continue to participate in the social networking session.

As represented by block 220, after detecting each of the one or more mobile devices, the system then determines whether a social networking application is enabled on each of the one or more mobile devices that enters or is within the social networking zone. In the instances, that the system determines that the social networking application is enabled on a mobile device, the system provides a notification, such as a push notification, indicating that the mobile device is in a social networking zone. The notification may also include a prompt or instructions for joining the social networking session (i.e., an invitation to join the social networking session) established in the social networking zone. In other embodiments, a mobile device having an enabled social networking application may automatically join the social networking session occurring with the social networking zone.

Still at block 220, when the system determines that the social networking application is not enabled on a mobile device, the system provides a notification to the mobile device prompting the user to enable the social networking application in order to join the social networking session occurring within the social networking zone.

At block 230, the system automatically generates a dynamic group for social networking that includes any of the one or more mobile devices that is located within the social networking zone. As such, the system instantly creates a social networking community comprising any of the mobile devices within the social networking zone and in some instances, in a reasonable proximity to the social networking zone (e.g., 10 ft. to 50+ ft.). The group for social networking is then defined by the one or more mobile devices that a) are located with the social networking zone, b) have an enabled social networking application, and c) in some embodiments, a host (e.g., business entity and/or host server). Thus, in many embodiments, the group for social networking is dynamic and changes based upon the one or more mobile devices that enter and exit the social networking zone. And so, other than having an enabled social networking application on a mobile device, no prior link is necessary between the mobile devices, the users of the mobile devices, and/or the host server for creating the social networking community.

In an embodiment of the invention, the social networking zone and the system-generated group for social networking are temporary. In such an embodiment, the social networking zone only exists contemporaneously with an event. The event may be any kind of event including predefined events, such as a party, a social gathering, a formal networking event, a sporting event, and/or the like. As an example, a host may establish an event, such as a gala event. The host may designate the hours of 7 pm to 10 pm for the gala event. Similarly, the host may setup a wireless router for initiating an instant social networking session that is spatially defined by the parameters of the space in which the gala event is held and further defined temporally by the hours during which the gala is held. In such an example, any user attending the gala having a mobile device having the appropriate social networking application can join the instant social networking community within the social networking zone defined by the space in which the gala is held and during the designated hours of 7 pm to 10 pm. While a user having a mobile device with the social networking application is attending the event, the user can participate in the social networking community formed by any other mobile device having an enabled social networking application that is also attending the gala event.

As represented by block 240, the system allows each user associated with each of the one or more mobile devices and/or a host device/server within the social networking zone to communicate and share social networking information. As an example, a user associated with a mobile device that is participating in the social networking zone may send a chat communication and/or share a user profile associated with the social network service with any other mobile device and/or host device that is also participating in the social networking zone. In another example, a host server/device may send chat communications and/or unique offers to each and/or any of the one or more mobile devices participating in the social networking zone. It will be understood that any kind of digital information can be shared within the social networking community encompassed by the social networking zone.

As represented by block 250, the system may individually disintegrate a social networking session of an individual user. For example, if any user of a mobile device participating in the social networking zone is subsequently positioned outside of the social networking zone, the system is configured to discontinue the user's ability to communicate and/or share social networking information with any other user and/or host within the social networking zone. In some embodiments, the system deletes and/or destroys any social networking information that was provided to the user while in the social networking zone and was accessible via a mobile device of the user who has moved from within the social networking zone to then be outside of the social networking zone. As an example, while in a social networking zone, a user may have displayed via a mobile device several user profiles of other users in the social network community that are participating in a particular social networking session. Upon leaving the social networking zone of the particular social networking session, the system may detect that the user has exited the social networking zone and subsequently, cease any transmission of social networking information from or to the mobile device of the user. In such an example, the system may cause the display of the user's mobile device to no longer display the several user profiles of individuals that are within the social networking zone. In some embodiments, the system may allow a user to exit the social networking zone, but allow the user to view and/or access social networking information of a particular social networking session for a predetermined period of time (e.g., 10 minutes, 20 minutes, or the like). In such an embodiment, once the predetermined time period has passed and the user has not re-entered the social networking zone, the system will terminate any transmissions of social networking information from the social networking session from the user's mobile device and/or to the mobile device of the user.

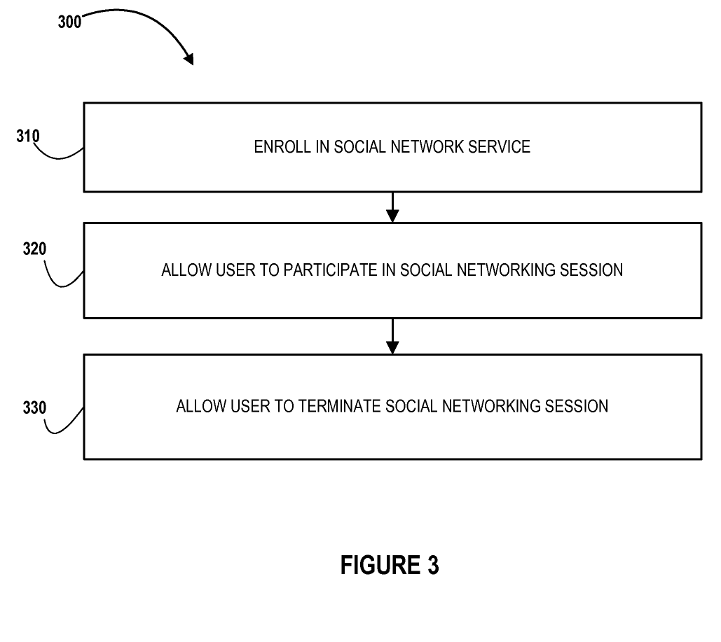

Referring now to FIG. 3, a general process flow 300 is provided for providing a proximity-based social network service, in accordance with an embodiment of the present invention. In accordance with some embodiments, one or more portions of process flow 300 are performed by an apparatus having hardware and/or software configured to perform one or more portions of the process flow 300. For example, in some embodiments, one or more portions of process flow 300 are performed, individually or collectively, by the mobile device 130, the social networking service server 120, and/or the host server 130 described in connection with FIG. 1, and/or by any one or more portions (e.g., applications, etc.) thereof. With respect to the mobile device 130, the mobile device 130 may be configured with Wi-Fi, hotspot, or similar capabilities for providing wireless connectivity to other mobile devices that are located within reasonable proximity of the mobile device 130. In such an example, the mobile device 130 is the wireless connectivity device which defines and enables a social networking zone for a social networking session. Thus, in some embodiments, the mobile device 130 may be the wireless router or wireless connective device referenced within system 100.

As represented by block 310, user enrolls in a social network service, such as, for example, by downloading a mobile social network application, and/or the like. During enrollment, the user may provide to a system of the social network service user profile information, which may include user demographics, user interests, and/or the like. The application generates a unique user identification number that links all profiles to a single user that links the user to the mobile device. The user may create multiple user profiles for the social networking service and separately designate for each of the multiple user profiles a geographic location or other location at which the associated user profile is used when the user is engaged in a social networking session. As an example, the user may create a first user profile for engaging in social networking sessions at church and so, the user would provide a geographic location for his church and tie the location to the first user profile. The user may then separately create a second user profile for engaging in a social networking session at the mall and so, the user would provide a geographic location for one or more malls and link the one or more locations of the malls to the second user profile. The user may be able to create an unlimited amount of user profiles for engaging in social networking sessions at an unlimited number of locations or events. In some, embodiments, the user profile specifically associated with the location or event may automatically populate to the screen of the user and other users that are engaged in a social networking session at a location linked to the user profile. In addition, the user may provide preferences for governing how the user desires to utilize the social network service. For example, the user may provide preferences relating to the enablement of the application. In such an example, the user may indicate that whenever it is detected that a wireless router or network associated with the social network service is in proximity to a mobile device of the user that the system should automatically send a prompt for enabling the social networking application and/or automatically enable the social networking application without requiring human intervention.

Sometime after enrolling in the social network service, the social networking system allows the user to participate in a social networking session, as represented by block 320. In some embodiments, the social networking session is a predefined event. In such an embodiment, sometime prior to the predefined event, the system may have presented to the user a list of one or more predefined events where one or more social networking sessions would be taking place. The user can select any of the one or more predefined events, such that upon arriving at the predefined event and entering a social networking zone associated with the event, the system would automatically upload social networking information associated with other users and/or hosts participating in the social networking zone. While participating in a social networking session, any other user participating in the social networking session can view a profile of the user, which may include an image of the user and other information about the user (e.g., education, place of work, home town, and the like). Similarly, the user would have access to and could view a profile of any other user participating in the networking session. The users participating in the social networking session may communicate via individual and/or group chat messaging. For the user, multiple individual and/or group chat messages that involve the user can exist simultaneously and be used by the user to communicate, during the social networking session, in real-time or substantially real-time communication with other users participating in the social networking session.

Similarly, a host of the predefined event can also share information and communicate with the user. For example, in some embodiments, a host of the predefined event is a business entity. In such an embodiment, the business entity may communicate offers, discounts, coupons, or collect data from and provide support to the user. In some embodiments, the offers may be user-specific and based on profile information associated with the specific user. As an example, a user may participate in a predefined event, such as a door buster sale occurring between the hours of 9 am to 11 am, being hosted by a department store. In such an example, the department store may act as a host for a social networking session by enabling a wireless router for creating a social networking zone in and/or around the parameters of its department store location. Customers within the social networking zone will be able to share information and communicate with any customer and/or the host within the department store-enabled social networking zone. While the user is participating in the social networking session within the department store, the department store acting as a host may communicate offers and/or deals to the user. Any deals or offers provided by the host department store may populate onto a graphical user interface of a mobile device of the user, such that the user may inspect the deal and/or accept the deal, if acceptance of the deal is required. In some embodiments, the user may perform transactions over the social networking service with one or more transaction terminals of and/or located at the host department store. For example, a user may accept a deal provided by the host using the social network service application on the mobile device of the user that requires that the user complete the transaction over the social network service's server or that is, at least partially, in communication with the social network service server during the transaction. In some embodiments, the user may share host information, offers, coupons, and the like with individuals outside the current social network zone.

As represented by block 330, the system allows a user to terminate a social networking session. In some embodiments, a user may expressly disable a social networking application on the user's mobile device, such that if the user is within one or more social networking zones, the user would no longer be able to communicate or share information with other users and/or hosts of one or more social networking sessions occurring within the zones. Additionally, in some embodiments, the system allows the user to terminate a social networking session by exiting the social networking zone or disabling the application, such that if the system cannot detect the user's mobile device, as being located within the social networking then the user device purged from the network session along with all related user and host information. Similarly, the session may be terminated when the system determines that the geographic location of the mobile of the user is outside of the geographic scope of the social networking zone.

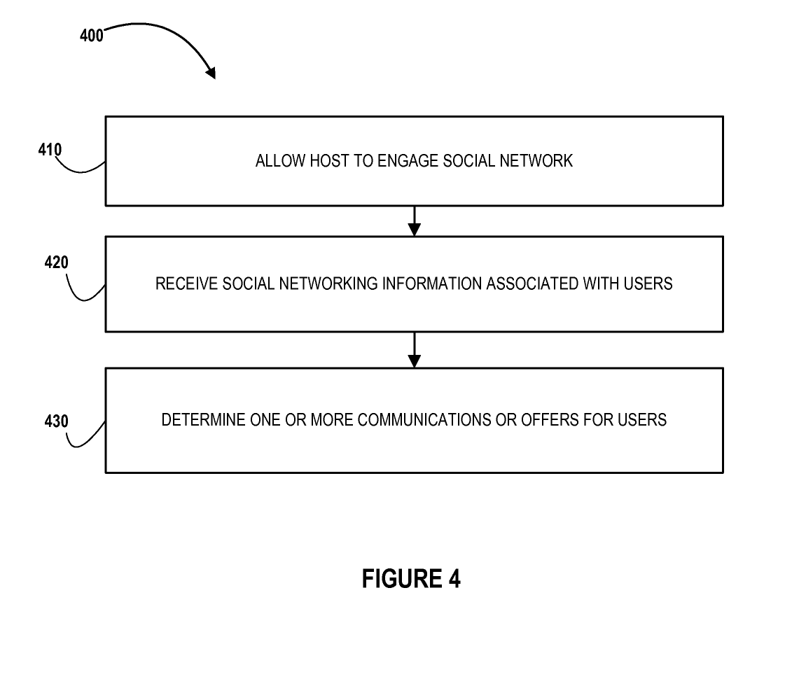

Referring now to FIG. 4, a general process flow 400 is provided for engaging a proximity social network by a host, in accordance with one embodiment of the present invention. In one embodiment, as represented by block 410, a proximity/local social network allows for a host to engage individual users of the proximity social network. A host may be, in some embodiments, a business merchant or other organization (e.g., Club/Bar, Malls/Shops, Cafes, Schools/Colleges, Churches, and/or the like). In other embodiments, a host may be an individual. The host, in some embodiments, is associated with a router that may be used in generating a social networking zone for conducting one or more social networking sessions by users/customers. The host may also be associated with or maintain a host server, which may be used to receive information from either a social networking service server and/or users having mobile devices that are in operative communication with the server during a social networking session. Thus, the host engages users in a proximity social network by using a router to generate a social networking zone and also by using a server to interact with the users within the social networking zone.

As represented by block 420, social networking information is uploaded to a host client. The social networking information may include user profiles and other data associated with one or more users who are in a social networking zone and are participating in a social networking session in which the host is engaged or participating in. The other data associated with the user may include past transaction information, user location information, shopping history with the host or related entity, various user preferences, and/or the like. In many embodiments, the social network service server hosts the social networking information and uploads the information from a database associated with the social network service server to a memory associated with a host server. In some embodiments, a combination of social networking information may be provided by both the social network service server and users participating in a social networking session involving the host. The host client may be a server utilized by the host for generating and/or providing deals to users, communicating with users, and/or otherwise used for obtaining user information.

As represented by lock 430, the host determines one or more communications or offers based at least partially on the social networking information associated with the one or more users participating in the social networking session in the social networking zone. In this way, the host may generate communications having user-specific deals, offers, or communications. The determined or generated communications may also be informative, educational, and/or alerts.

Upon determining a communication, the system allows the host to provide the communication to each of the one or more users participating in a social networking session involving the host that are within the social networking zone. Users may receive the communications from the host on one or more mobile devices associated with each of the users and may act on the communication by accepting a deal or offer, by responding to the host, by communicating an inquiry to the host, and/or the like. Thus, during the social networking session a host and one or more users can easily interact and communicate with one another.

In some additional embodiments, a host may provide a means, such as a local wireless router, for connecting to the Internet. In such additional embodiments, users located within the social networking zone or range of the router may use the router to connect to the Internet to access a social networking webpage or website (i.e., Qwintro.com). The users may login via the social networking webpage or website in order to participate in a social networking session involving the router, other users, and which may be hosted by a social networking service provider server(s).

While the process flow of FIG. 4 generally discloses a hosted social networking session, it will be understood that, in some embodiments, may not include a host. In such embodiments, the social networking session may be a hostless social networking session. For example, a box or device having the social networking application embedded therein may include wireless connectivity functionality or capabilities or otherwise is connected to or operatively connected to a router or wireless connectivity device. In such an example, users may connect to the box, device, wireless connectivity device and the box or device allows the users to participate in a social networking session that is being maintained by the box or device.

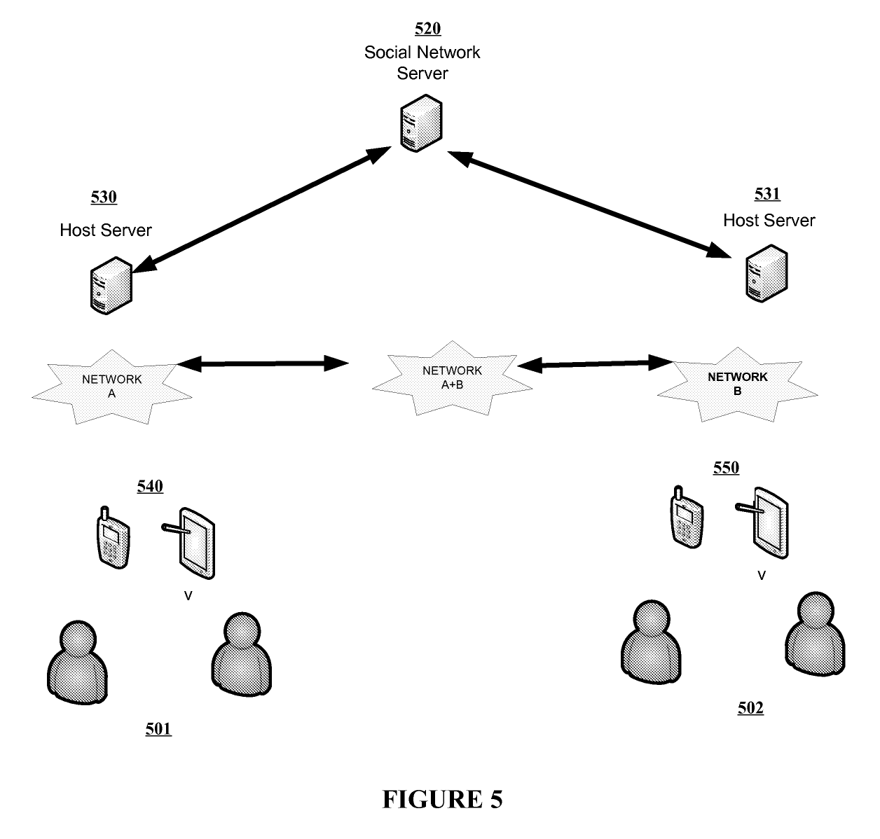

Referring now to FIG. 5, a system environment 500 for generating an instant social network session between at least two proximity-based social networking sessions is provided, in accordance with embodiments of the present invention. System environment 500 may include many of the features and element of system environment 100, although every feature is not shown. In that regard, in system environment 500, social networking zones and social networking sessions may also be established. However, as presently illustrated, the system environment 500 includes a network A, network B, and network A+B, first users 501, second users 501, a social network server 520, a first host server 530, a second host server 531, first mobile or computing devices 540 and second mobile or computing devices 550.

In some embodiments, the social network service server 520, the host server 530, and mobile or computing devices 540 are each operatively and selectively connected to the network A, which may include one or more separate networks. Also, the social network service server 520, the host server 531, and mobile or computing devices 550 are each operatively and selectively connected to the network A, which may include one or more separate networks.

According to various embodiments of the present application, a first social networking session may be established at network A and a second social networking session may be established at network B. Although, in some embodiments, it is described that the social networking zones and/or social networking sessions may be limited by the range or the defined proximity of a social networking zone, in embodiments implemented in accordance with system 500, two or more disparate or geographical separate social networking sessions may be linked or otherwise placed in communication with each other at network A+B so that the users in the social networking session established at network A and the users in the social networking session established at network B may interact, communicate, and share information with each other. Similarly, the first host server 530 may communicate, interact, share, or collect information with the second host server 531 and/or any of the users which are connected.

While linked at network A+B, the host servers, users, and social network service provide may perform any process or steps described herein including, but not limited to, the processes associated with process flows 200, 300, and 400 and the functionality and features described in FIGS. 1, 1A, and 1B.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

What is claimed:

1. A system for proximity-based social networking, the system comprising:
two or more computing devices, wherein each of the two or more computing devices comprises a storage device storing a social networking application and a user profile;
a connectivity device that connects to each of the two or more computing devices, at the same time, when each of the two or more computing devices are within a defined proximity of the connectivity device, wherein via the connectivity device a social networking session is established between the two or more computing devices using the social networking application that is stored on the storage device of each of the two or more computing devices.

2. The system according to claim 1, further comprising a host server that is in operative communication with the connectivity device, wherein the host server manages the connectivity device.

3. The system according to claim 1, wherein the connectivity device comprises a wireless router having a defined radius of connectivity.

4. The system according to claim 3, wherein the social networking session is established within the defined radius of connectivity of the wireless router.

5. The system according to claim 1, wherein the connectivity device comprises a mobile computing device of user that which comprises wireless routing capabilities.

6. The system according to claim 1, wherein the connectivity device establishes a social networking zone, wherein the social networking zone is a geographical area defined by a connectivity range of the connectivity device, wherein only the computing devices within the social networking zone can engage in the social networking session.

7. The system according to claim 1, wherein the social networking session is established without a use of Internet.

8. A system for providing a proximity-based social networking session, the system comprising:
a connectivity device generating a wireless local area network; and
a first mobile computing device of a first user;
a second mobile computing device of a second user, wherein the first and the second mobile computing devices each comprise a storage device, wherein the storage device for each of the first and second mobile computing devices comprises a user profile for a social networking service and social networking information, and
wherein a social networking session between the first mobile computing device and the second mobile computing device only when the first and the second mobile computing devices are geographical positioned within a defined range of the wireless local area network generated by the connectivity device.

9. The system according to claim 8, further comprising a host server that is in operative communication with the connectivity device, wherein the host server manages the connectivity device.

10. The system according to claim 8, further comprising a social networking service provider that is in operative communication with the connectivity device, wherein the social network service provider comprises a server or a computer that manages the connectivity device.

11. The system according to claim 8, wherein the connectivity device is a wireless router having a defined radius of connectivity.

12. The system according to claim 11, wherein the social networking session is established within the defined radius of connectivity of the wireless router.

13. The system according to claim 12, wherein the social networking session is established without a use of Internet.

14. A method for establishing a proximity-based social networking session, the method comprising:
establishing, by a connectivity device, a social networking zone, wherein the social networking zone is geographically defined by a connectivity range of the connectivity device;
connecting, via the connectivity device, a plurality of computing devices that are within the social networking zone established by the connectivity device; and
maintaining, via the connectivity device, a social networking session between at least two of the plurality of computing devices that are within the social networking zone, wherein the social networking sessions comprises sharing user information between at least two or more of the plurality of computing devices within the social networking zone.

15. The method according to claim 14, wherein the plurality of computing devices are mobile devices, wherein each of the mobiles devices is associated with at least one user.

16. The method according to claim 14, wherein maintaining, via the connectivity device, the social networking session is performed by a host, wherein the host is a business merchant that is different from a social network service provider.

17. The method according to claim 16, wherein the host collects information from and shares information or offers with one or more of the plurality of computing devices within the social networking zone and that are engaged in the social networking session.

18. The method according to claim 17, wherein the plurality of computing devices comprise mobile computing devices.

19. The method according to claim 14, wherein the social networking session is established without a use of Internet.
